(19) United States
(12) Patent Application Publication
(10) Pub. No.: US 2025/0091949 A1
(43) Pub. Date: Mar. 20, 2025

(54) CALCIUM ALUMINA CEMENT BASED MORTAR COMPOSITION FOR FAST REPAIR ON CONCRETE AREA

(71) Applicant: ÇIMSA ÇIMENTO SANAYI VE TICARET ANONIM SIRKETI, Mersin (TR)

(72) Inventors: Buket POLAT, Mersin (TR); Ipek BULUT, Mersin (TR); Özge GÖKÇE, Mersin (TR); Vahit Ersin IMREN, Mersin (TR); Berrak Erbuga AVCIOGLU, Munich (DE)

(21) Appl. No.: 18/576,977

(22) PCT Filed: Sep. 19, 2023
(86) PCT No.: PCT/TR2023/050979

§ 371 Date: Jan. 5, 2024

(30) Foreign Application Priority Data
May 17, 2023 (TR) 2023/005586

(51) Int. Cl. C04B 28/06

(52) U.S. Cl. CPC C04B 28/06

(57) ABSTRACT

Disclosed is a concrete mortar composition containing 10-50% calcium aluminate cement, 2-10% lithium salt, 5-25% setting accelerator admixture, 30-75% aggregate by weight, suitable for use wherever required, such as runways, driveways and airplane parking areas for the renovation of large concrete traffic areas such as airports in a very short time.

### TECHNICAL FIELD

The invention relates to a mortar composition based on calcium aluminate cement for rapid (/quick/fast) repair of concrete areas.

In particular, the invention relates to a calcium aluminate cement based mortar composition suitable for use wherever required, such as runways, driveways and airplane parking areas, for the rapid renovation of large concrete traffic areas such as airports.

### KNOWN STATE OF THE ART

Today, large concrete areas under heavy traffic, such as airports, must remain operational at all times during working hours. Any deterioration in concrete areas such as airport runways, driveways or airplane parking areas can only be repaired at night, causing the area to become inoperable.

Portland cement is widely used in repair work to repair or reinforce areas where a lot of corrosion or erosion has occurred, such as bridge decks, pavement road surfaces and external walls of concrete structures. However, durable Portland cement has the advantage of superior workability compared to general cement, but its high setting time and high water permeability make it inadequate for repairs of open concrete sites.

The addition of Calcium Aluminate Cement changes the setting acceleration mechanism of Portland Cement. Mixtures prepared only with Portland Cement may be insufficient to provide different solutions for different needs such as high temperature, early strength, fast setting and crack-free structure. For this reason; binding systems have been created by combining Portland Cement Calcium Aluminate Cement and chemical additives in different ratios.

Calcium aluminate cement (CAC) is obtained by sintering a mixture of aluminous and calcareous materials in appropriate proportions and grinding the resulting product into a fine powder. Compared to Portland cement (OPC), the annual production of calcium aluminate cement is very small. However, when compared to Portland cement performance, they have unique properties that make them preferred in special applications. When used in traditional mortars, they provide rapid strength development even at low temperatures, high temperature resistance, high refractory performance, resistance to aggressive conditions.

Calcium aluminate cement is also widely used in different combinations with other minerals and admixtures, including Portland cement and calcium sulphate. In such uses, CACs are used to provide rapid hardening, early high strength, controlled expansion and resistance to shrinkage.

For example, patent numbered KR101814725B1 describes a shrinkage-reducing type of fast-setting cement concrete composition and a road pavement maintenance construction method using it. The composition of the fast-setting binder mentioned in that patent is 10-60 wt % normal granular Portland cement; 5-50 wt % calcium sulfoaluminate; 1-40 wt % calcium aluminate cement; 1-40 wt % sericite; 1-40 wt % blast furnace slag powder; 0.1-20 wt % gypsum; 0.01-20 wt % bauxite; 0.01-10 wt % cyclohexylamine nitrite; 0.01-10 wt % lithium carbonate; and 0.01-10 wt % sodium carbonate. Since Portland cement was used in the relevant patent, a large number of minerals and additives were needed. It also describes the need for an additional expansion agent and a shrinkage reducing agent in the recipe for use in open areas.

The high setting time of Portland and calcium aluminate cement mixtures in open area repair has necessitated the development of compositions based only on calcium aluminate cement.

Basically, the cement paste that obtained by combining cement and water first takes a plastic consistency and hydration reactions start between them. These reactions give the cement paste binding properties, that is, the ability to gain strength. The speed of hydration and how perfect it will be depending on the fineness of the cement, the amount of cement and the composition of the cement. However, it is also affected by the temperature and humidity of the environment. All hydraulic binders exposed to high humidity undergo prehydration (aging). Since calcium aluminate cements are more reactive than Portland cements and their performance is expected earlier, the effect of moisture is noticed faster. The effects of aging of calcium aluminate cements can be reduced by correct mineralogy and recipe design. There is a need to develop mortar recipes based on calcium aluminate cement that provide high early strength, fast drying, anti-shrinkage properties to ensure rapid repair in open concrete sites.

As a result, due to the above-mentioned drawbacks and the inadequacy of the existing solutions, it has become necessary to develop an improvement in the relevant technical field.

### Aim of the Invention

The invention is inspired by existing conditions and aims to solve the above-mentioned problems.

The aim of the invention is to provide a mortar composition based on calcium aluminate cement suitable for use wherever required, such as runways, driveways and aircraft parking areas for the renovation of large concrete traffic areas such as airports in a very short time. Unlike conventional concrete calcium aluminate cement hardens much faster and can be completely filled after 1-2 hours, depending on the desired open time. Compared to other types of fast-setting concrete, it provides sufficient time for placing and preparing the concrete. The fast-setting inventive composition is therefore suitable wherever large concrete traffic areas need to be renovated in a very short time. Thanks to its ingredients, it also extends the service life of conventional concrete.

In order to fulfill the aforementioned objects, the invention provides a calcium aluminate cement based concrete mortar composition that provides rapid repair of concrete and comprises 10-50% calcium aluminate cement, 2-10% lithium salt, 5-25% setting accelerator additive, 30-75% aggregate by weight.

The structural and characteristic features and all the advantages of the invention will be more clearly understood the detailed description give below and therefore the evaluation should be made by taking this detailed description into consideration.

### DETAILED DESCRIPTION OF THE INVENTION

In this detailed description, the preferred embodiments of the inventive mortar composition are described only for the purpose of a better understanding of the subject matter.

The invention relates to a mortar composition based on calcium aluminate cement, which can meet the demand for high early strength in concrete repair projects at road and airport sites.

TABLE 1
Inventive mortar composition

| Content | By weight (%) |
|---|---|
| Calcium aluminate cement | 10-50 |
| Lithium salt | 2-10 |
| Setting accelerator additive | 5-25 |
| Aggregate | 30-75 |

Calcium aluminate cements (CAC) used in the mortar composition of the invention differ chemically, physically and mineralogically from Portland cements (OPC). The main raw materials of Portland cement are clay and limestone. The main oxides originating from the raw materials are CaO and SiO₂. In the production of calcium aluminate cement, bauxite, an alumina source, is used as raw material. The main oxide is Al₂O₃. The mineralogical properties of calcium aluminate cement and Portland cement are also different due to the different raw materials used in their production. All calcium aluminate cements contain predominantly mono calcium aluminate, i.e. CA phase. Portland cements (OPC), on the other hand, contain C3S and C2S phases depending on the components from the raw material. Portland cements form the C2S and C3S phases with calcium and silicon oxides, resulting in C—S—H and C—H hydrates when reacted with water. Calcium aluminate cement basically forms monocalcium aluminate (CA) with calcium and aluminum oxides, forming calcium aluminate hydrates when combined with water. The main phase for all types of calcium aluminate cement is the monocalcium aluminate (CA) phase and is responsible for the main properties of the cement. Another phase, the mefenite phase (C12A7), usually reacts rapidly with water and also plays an important role in the nucleation of calcium aluminate hydrates. The most important known property of calcium aluminate cement is that it completes its strength development in 24 hours. So much so that; much more than the strength gained by Portland cement in 28 days can be obtained in 24 hours with calcium aluminate cement. For this reason, it is suitable for use in tunnels, road applications and field concretes that require cold weather and early age high strength.

Calcium aluminate cement preferred in the mortar composition of the invention provides adjustable setting time, thermal resistance up to 1300° C., high early and final strength, high abrasion resistance. The calcium aluminate cement used reaches very high strength values within 6 hours. It gains 95% of its strength in the first 24 hours. It provides various advantages such as easy application even in winter conditions with sub-zero temperatures (down to −5° C.).

The technical specifications of the preferred calcium aluminate cement are as follows:

### Phase Composition:

Main Mineral Phase: CA
Auxiliary Mineral Phase: C12A7, C4AF

### Chemical Composition:

| Al₂O₃ (%) | CaO (%) | SiO₂ (%) | Fe₂O₃ (%) |
|---|---|---|---|
| ≥38.0 | ≤38.0 | ≤5.0 | ≤19.0 |

| TiO₂ (%) | MgO (%) | SO₃ (%) | Na₂Eq Alkaline (%) |
|---|---|---|---|
| ≤3.0 | ≤1.0 | ≤0.2 | ≤0.3 |

### Physical and Mechanical Properties:

| | | |
|---|---|---|
| Completion of Setting [min] | ≥180 | EN 196-3 |
| End of Setting [min] | ≤400 | EN 196-3 |
| Specific Gravity [g/cm³] | ≤3.2 | EN 196-6 |
| Compressive | 6 hr ≥ 28.0 | EN 196-1 |
| Strength [MPa] | 24 hr ≥ 60.0 | |
| Residue on 45 Micron Sieve [%] | ≤20 | EN 196-6 |
| Residue on 90 Micron Sieve [%] | ≤4.0 | EN 196-6 |
| Blaine [cm²/g] | ≥2,600 | EN 196-6 |

The aggregate used in the mortar composition of the invention is an aggregate product obtained from calcium aluminate clinker. Its main feature is that the recipes can be optimized to obtain the perfect grain size distribution. With its high performance, it has the ability to maintain its integrity up to 1250° C. When used in combination with Calcium Aluminate cement at a ratio of 30-75% by weight in the total composition, it provides high early strength, high temperature resistance and increases the overall abrasion resistance of the system. 10 The technical specifications of the preferred aggregate are as follows:

### Phase Composition:

Main Mineral Phase: CA
Auxiliary Mineral Phase: C12A7, C2AS, C4AF

### Chemical Composition:

| Al₂O₃ (%) | CaO (%) | SiO₂ (%) | Fe₂O₃ (%) |
|---|---|---|---|
| ≥38.5 | ≤39.0 | ≤5.0 | ≤19.0 |

| TiO₂ (%) | MgO (%) | SO₃ (%) | Na₂Eq Alkaline (%) |
|---|---|---|---|
| ≤3.0 | ≤1.0 | ≤0.2 | ≤0.3 |

### Physical and Mechanical Properties:

| | |
|---|---|
| Hardness (Mohs) | ≤7.5 |

| Fineness | | | | | | | |
|---|---|---|---|---|---|---|---|
| Module | 2.76 | 6.5 | 5.08 | 8 | 8 | 8 | 4.23 |
| Quantity (%) | 55 | 30 | 15 | 0 | 0 | 0 | 100 |

The setting accelerator admixture used in the mortar composition of the invention shortens the setting time of fresh concrete and increases the rate of formation of hydrates in the cementitious system. They shorten the curing time. It is advantageous to use especially in winter months. The setting accelerators used within the scope of the composition of the invention are individuals or combinations selected from the group comprising calcium chloride, sodium nitrate and calcium nitrate.

The content and technical specifications of the preferred setting accelerator additive are as follows:

The use of the setting accelerator admixture at a rate of 5-25% by weight in the total composition of the inventive mortar increases the early strength performance of the inventive composition by shortening the setting time and increasing the final strength. While setting delay is experienced below this ratio, sudden hardening is experienced when used above this ratio.

Lithium salt used in the mortar composition subject to the invention is individuals or combinations selected from the group consisting of lithium carbonate, lithium hydroxide, lithium hydroxide, lithium chloride. In the mortar composition of the invention, economical Lithium carbonate (Li₂CO₃) produced as dry powder, which creates a synergistic effect with the setting accelerator additive, is preferred. Addition of Lithium Carbonate accelerates the hydration process in the system. It can provide very fast setting of concrete in mortars in ground applications where early setting is required, in special mortars produced to minimize the negative effects that may arise from the danger of frost by providing early setting of the mortar in cold weather applications, in mortars where high strength is required. The use of lithium carbonate at a rate of 2-10% by weight in the total composition of the inventive mortar improves the early strength performance of the inventive composition by shortening the setting time and increasing the final strength. Below this ratio, there is a delay in early strength, while above this ratio, workability deteriorates.

In the samples prepared with the inventive mortar composition, the dry ingredients (cement, aggregate, lithium carbonate) are mixed homogeneously. The setting accelerator admixture is dissolved in water or added to the dry mixture at the same time with water and the concrete mortar is prepared. The contents of the concrete recipe for the samples are given in the table below. The concrete remains workable for up to 45 minutes and can be settled by vibration. Lithium carbonate should be homogeneously distributed in the mixture. Since the hydration temperature of calcium aluminate cement is high, curing should be done well. Especially after the concrete pouring is completed, the concrete surface should be watered and covered with a tarpaulin. Compressive strengths were measured 2 hours and 6 hours after the samples were combined with water.

TABLE 2
Samples prepared within the scope of the invention

| Cement Source | Calcium Aluminate Cement |
|---|---|
| Cement Dosage | 10-50% |
| Setting accelerator | 5-25% |
| Lithium salt | 2-10% |
| Aggregate | 30-75% |

Theoretical Unit Weight

| | | |
|---|---|---|
| Consistency | 10-20 | cm |
| Water quantity | 150-200 | kg/m³ |
| Room Temperature | 23° | C. |
| Concrete Temperature | 25.6° | C. |
| Setting Time₍ₛₜₐᵣₜ₎ | ≤45 | mn |

| | |
|---|---|
| Air rate | %2.3 |

Concrete recipe strength values

| | | |
|---|---|---|
| 1st Hour | ≥15 | MPa |
| 2nd Hour | ≥20 | MPa |
| 3rd Hour | ≥25 | MPa |
| 6th Hour | ≥34 | MPa |

### Example 1

In one embodiment of the invention, the concrete mortar composition comprises 30% calcium aluminate cement, 5% lithium carbonate, 15% setting accelerator and 50% aggregate by weight. The concrete mixture prepared with 150-200 kg/m³ water reached a strength of 17.5 MPa in 1 hour and 26.3 MPa in 3 hours. This concrete can be processed for 30 minutes.

### Example 2

In another embodiment of the invention, the concrete mortar composition consists of 30 wt % calcium aluminate cement, 5 wt % lithium carbonate, 20 wt % setting accelerator and 45 wt % aggregate. The concrete mixture prepared to contain 150-200 kg/m³ water reached a strength value of 15 MPa in 1 hour and 25 MPa in 3 hours. This concrete can be processed for 45 minutes.

1. A calcium aluminate cement based concrete mortar composition that provides fast repair in the concrete field, the composition comprising: 10-50% calcium aluminate cement, 2-10% lithium salt, 5-25% setting accelerator additive, and 30-75% aggregate by weight.

2. The composition according to claim 1, wherein the calcium aluminate cement has a Blaine value ≥2,600 g/cm².

3. The composition according to claim 1, wherein the aggregate is calcium aluminate aggregate with a hardness value of ≤7.5.

4. The composition according to claim 1, wherein the setting accelerator additive is an individual or combination selected from the group consisting of calcium chloride, sodium nitrate and calcium nitrate.

5. The composition according to claim 1, characterized in that, wherein the lithium salt is an individual or combination selected from the group consisting of lithium carbonate, lithium hydroxide, lithium chloride.

6. The composition according to claim 1, wherein the composition prepared with 150-200 kg/m³ water is processed for ≤45 minutes.

7. The composition according to claim 1, wherein the composition prepared with 150-200 kg/m³ water provides strength values ≥15 MPa in 1 hour and ≥25 MPa in 3 hours.
